(19) United States
(12) Patent Application Publication
(10) Pub. No.: US 2016/0250744 A1
(43) Pub. Date: Sep. 1, 2016

(54) Hand-held power tool

(71) Applicant: Robert Bosch GmbH, Stuttgart (DE)

(72) Inventor: Ralf Windsheimer, Stuttgart (DE)

(21) Appl. No.: 15/045,377

(22) Filed: Feb. 17, 2016

(30) Foreign Application Priority Data
Feb. 27, 2015 (DE) 10 2015 203 575.1

(51) Int. Cl. B25F 5/02; B25B 21/00; B25F 5/00

(52) U.S. Cl. CPC B25F 5/026; B25F 5/001; B25B 21/00

(57) ABSTRACT

A hand-held power tool includes: a motor housing; an output spindle; at least one metal housing that includes a receiving area for fastening an additional handle and a connection area formed as one piece with the receiving area for a free-of-play, rotatably-fixed connection to the motor housing; and an insulation unit, which electrically insulates the output spindle and the metal housing from one another in an assembled state.

### BACKGROUND OF THE INVENTION

1. Field of the Invention

The present invention relates to a hand-held power tool including a motor housing, an output spindle, and a metal housing, which includes a receiving area for fastening an additional handle.

2. Description of the Related Art

A hand-held power tool including a motor housing, an output spindle, a metal housing, which includes a receiving area for fastening an additional handle has previously been provided.

### BRIEF SUMMARY OF THE INVENTION

A hand-held power tool, in particular, a cordless screwdriver, is provided, including a motor housing, an output spindle, at least one metal housing, which includes a receiving area for fastening an additional handle and a connection area formed as one piece with the receiving area for a free-of-play, rotatably fixed connection to the motor housing, and an insulation unit, which electrically insulates the output spindle and the motor housing from one another in an assembled state.

In this way, it is possible to fasten an additional handle free of play to the hand-held power tool. A structurally simple and stable fastening option for an additional handle may be provided. The additional handle may be particularly securely fastened in a structurally simple manner. A user may be particularly effectively protected from a current flow and/or a voltage contact hazardous to a human. A risk of an electric shock as a result of drilling into an electric line may be minimized. A greater user comfort and/or a higher user safety may be achieved.

A “hand-held power tool” in this context is understood to mean, in particular, a power tool for machining work pieces, advantageously, however, a cordless screwdriver, a power drill, a drill hammer and/or percussion hammer, a screwdriver, a milling tool, a grinder, an angle grinder, a garden tool and/or a multi-functional tool. A “cordless screwdriver” in this context is intended to mean, in particular, a screwdriver operable independently of the power supply. The cordless screwdriver preferably includes a rechargeable energy storage unit and/or an electrical and mechanical interface to a rechargeable battery pack having a rechargeable energy storage unit. A “motor housing” in this context is intended to mean, in particular, a housing, which is provided for mounting a drive unit for the hand-held power tool and/or for protecting the drive unit from environmental influences, such as moisture, dirt or dust, and/or mechanical stresses, such as shocks. An “output spindle” in this context is intended to mean, in particular, an element for axial transmission of a rotational movement generated by the drive unit and/or of a torque. The output spindle is preferably provided for transmitting a rotational movement and/or a torque to a tool receptacle of the hand-held power tool. The output spindle is preferably designed separately from the tool receptacle. The output spindle and the tool receptacle are preferably rotatably fixedly and electrically conductively connected to one another. A “metal housing” in this context is intended to mean, in particular, a housing, which is provided to absorb and/or transfer support forces and/or retaining forces. The metal housing preferably surrounds the output spindle in an assembled state by at least as much as 270 degrees, preferably by as much as 300 degrees, and particularly preferably by at least as much as 330 degrees. The metal housing is preferably designed as an external housing. The metal housing preferably has an at least essentially hollow cylindrical shape. The metal housing is preferably formed at least essentially from a light alloy containing aluminum, magnesium and/or zinc or, alternatively, at least essentially from steel or another metal appearing suitable to those skilled in the art. The receiving area is preferably ring-shaped for fastening an additional handle. The receiving area in an assembled state is preferably situated axially overlapping with the output spindle. The receiving area in an assembled state is preferably situated coaxially relative to a rotation axis of the output spindle. An outer circumference of the receiving area preferably includes a profile for an at least partially form-locking connection with the additional handle. The connection area of the metal housing preferably includes at least one receptacle for a bolt connection, preferably for a screw connection with the motor housing. An “insulation unit” in this context is intended to mean, in particular, a unit made of a solid, electrically non-conductive material, preferably of a plastic. The insulation unit is preferably made of a polymer such as, for example, polyamide, polycarbon or ABS, a fiber composite or another material appearing suitable to those skilled in the art. The material of the insulation unit preferably exhibits a dielectric strength of at least 20 kV/mm, preferably of at least 40 kV/mm and particularly preferably of at least 80 kV/mm.

The receiving area for fastening an additional handle is advantageously spaced axially apart from the tool receptacle. The tool receptacle advantageously includes chuck jaws, which are spaced axially apart relative to the receiving area in an assembled state. In this way, it is possible to further enhance the protection for the user. A particularly safe hand-held power tool may be provided. A smaller diameter of the receiving area may be achieved and a particularly compact additional handle provided.

The insulation unit is advantageously provided for a rotatable, at least partially radial, mounting of the output spindle. In this way, a particularly compact hand-held power tool may be provided. The insulation unit preferably includes at least one bearing position, preferably at least one additional bearing position, each of which is provided for transmitting a radial force and/or an axial force between the output spindle and the insulation unit. Each of the bearing positions preferably includes at least one antifriction bearing, for example, a ball bearing or a roller bearing.

In one advantageous embodiment, the insulation unit includes a transmission housing. In this way, it is possible to particularly advantageously utilize an existing installation space. A compactness of the hand-held power tool may be further enhanced. A “transmission housing” in this context is intended to mean, in particular, a housing, which is provided for mounting and/or protecting a gear box of the hand-held power tool coupled to a drive unit. The transmission housing is preferably provided for mounting at least one planetary gear stage of the gear box. The insulation unit and the transmission housing are preferably designed as one piece.

It is further provided that the hand-held power tool includes at least one axial cross sectional plane, in which the insulation unit is situated radially between the output spindle and the receiving area. A particularly stable and/or robust hand-held power tool may be provided in this way. The output spindle, the insulation unit and the receiving area are situated preferably axially overlapping.

In one advantageous embodiment, the metal housing includes at least one guide element, which is provided for radially supporting and/or guiding the insulation unit. In this way, a force of the user with the aid of the additional handle may be particularly effectively transmitted to the output spindle. A particularly simple and/or reliable assembly of the hand-held power tool may be achieved. The guide element is preferably provided for radially guiding and/or centering the insulation unit during an assembly operation. The hand-held power tool preferably includes a cross sectional plane, in which the output spindle, the insulation unit, the guide element and the receiving area are situated.

It is further provided that the metal housing includes at least one support element, which is provided for supporting the insulation unit in the axial direction in an assembled state. In this way, the insulation unit may be retained in the hand-held power tool in a structurally particularly simple manner. The guide element and the support element are preferably designed as one piece. The support element preferably forms a form-locking connection with the insulation unit, at least in an axial direction.

In one advantageous embodiment, the hand-held power tool includes at least one antifriction bearing for the rotatable mounting of the output spindle, which includes at least one outer ring directly connected to the insulation unit. In this way, forces acting on the output spindle may be particularly effectively supported in the insulation unit. The output spindle preferably includes an axial stop for a contact with a bearing ring of the antifriction bearing. The insulation unit preferably includes an axial stop for a contact with a bearing ring of the antifriction bearing.

In one advantageous embodiment, the insulation unit projects axially beyond the metal housing in an assembled state. That the insulation unit “projects” beyond the metal housing is intended in this context to mean, in particular, that the insulation unit projects beyond the metal housing on the drive side and/or output side in relation to a drive axis and/or working axis of the hand-held power tool. In this way, the metal housing may be particularly effectively electrically insulated and/or shielded from the output spindle. In addition, a force introduced by a user into the insulation unit with the aid of the additional handle may be particularly effectively absorbed and/or supported. An axial extension of the metal housing is preferably smaller than an axial extension of the insulation unit.

It is further provided that the metal housing also includes a bracing element, which extends at least essentially perpendicularly to a metal housing axis. In this way, a particularly durable and/or inherently stable metal housing may be provided. The at least one bracing element and the support element are preferably designed as one piece. The metal housing preferably includes at least one additional bracing element.

It is further provided that the hand-held power tool includes a torque clutch, which includes a blocking element, which is provided in at least one operating state for disengaging the torque clutch and for supporting a blocking force against the metal housing. In this way, the blocking element may be supported in the hand-held power tool in a structurally simple manner. A particularly compact torque clutch may be provided. The torque clutch preferably includes a setting element for setting a maximal torque transmittable to the output spindle, which is situated axially between the tool receptacle and the receiving area for the additional handle. In this way, the setting element may be situated in a user-friendly and readily accessible manner.

It is further provided that the insulation unit includes at least one insulation element, which electrically insulates the blocking element and the metal housing from one another in an assembled state. In this way, a protection for the user is further enhanced. The insulation element is preferably provided for a contact with the bracing element of the metal housing. In this way a structurally simple design of the insulation element may be achieved.

The hand-held power tool according to the present invention is not intended to be limited to the use and specific embodiment described above. The hand-held power tool according to the present invention may, in particular, include a number of individual elements, components and units different from a number cited herein for fulfilling a functionality described herein.

### BRIEF DESCRIPTION OF THE DRAWINGS

FIG. 1 shows a system including a hand-held power tool according to the present invention, having an opened motor housing and a rechargeable battery device.

FIG. 2 shows a perspective view of a part of the hand-held power tool.

FIG. 3 shows a partially cutaway perspective view of the part of the hand-held power tool.

### DETAILED DESCRIPTION OF THE INVENTION

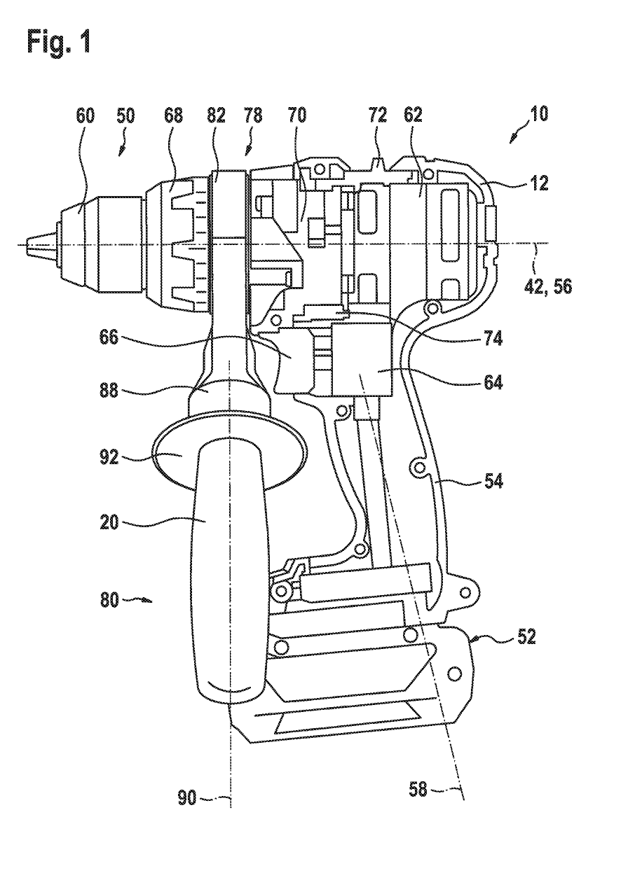

FIG. 1 shows a system 50 including a hand-held power tool 10, an additional handle 20 and a rechargeable battery device 52. System 50 is designed as a hand-held tool system. Hand-held power tool 10 includes a motor housing 12, an output spindle 14, and a metal housing 16, which includes a receiving area 18 for a fastening of an additional handle 20 and a connection area 22 formed with receiving area 18 as one piece for a free-of-play, rotatably fixed connection to motor housing 12. Hand-held power tool 10 also includes an insulation unit 24, which electrically insulates output spindle 14 and metal housing 16 from one another in an assembled state. Hand-held power tool 10 in the present exemplary embodiment is designed as a cordless screwdriver. Hand-held power tool 10 in the present exemplary embodiment is designed in the shape of a pistol. Hand-held power tool 10 includes a handle housing 54, which forms a handle. Motor housing 12 and handle housing 54 are designed as one piece in the present exemplary embodiment. To use hand-held power tool 10, the handle is grasped by a user with at least one hand.

Hand-held power tool 10 includes a drive and working axis 56 and a handle axis 58. Drive and working axis 56 and handle axis 58 together encompass an angle of approximately 80 degrees. It is conceivable that drive and working axis 56 and handle axis 58 encompass an angle, which includes a value in a value range of between 60 degrees and 90 degrees or another value appearing suitable to those skilled in the art. It is equally conceivable that drive and working axis 56 and handle axis 58 are situated flush relative to one another. Hand-held power tool 10 includes a tool receptacle 60, which is provided for holding replaceable insertion tools such as, for example, screw bits, drill bits, stirrers, grinding insertion tool or cutting tools. Tool receptacle 60 in the present exemplary embodiment is designed as a chuck. It is also conceivable that tool receptacle 60 is designed as a polygonal receptacle or as another type of receptacle.

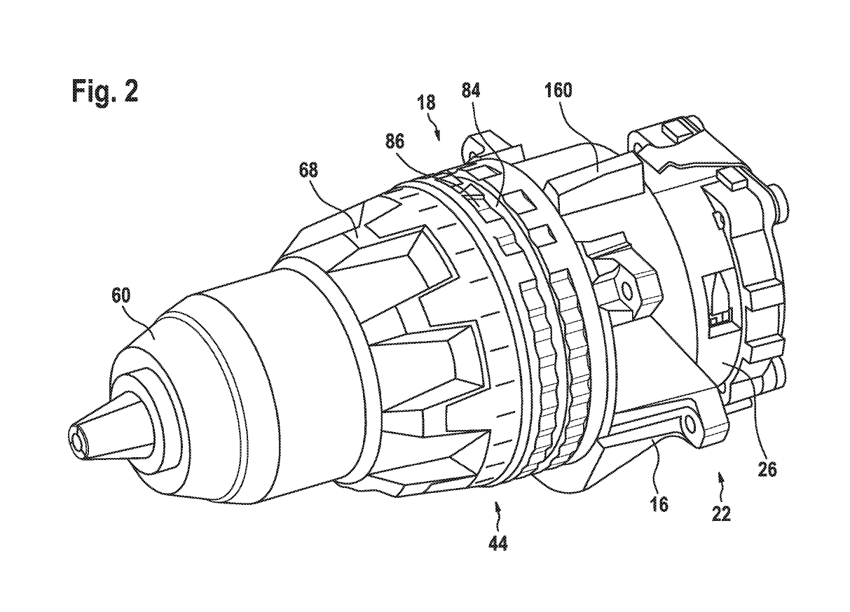

Hand-held power tool 10 includes an electric drive unit 62. Electric drive unit 62 includes an electric motor. Motor housing 12 includes a receptacle for the electric motor. Motor housing 12 is provided for storing the electric motor and for protecting it from environmental influences such as, for example, dust, moisture and/or mechanical effects. Hand-held power tool 10 includes an electric switch unit 64, which is provided for switching drive unit 62 on and/or off and/or for setting a speed of drive unit 62 and/or a generated torque of drive unit 62. Switch unit 64 includes an actuation element 66, which is provided for actuation by a user. Actuation element 66 is designed as a spring-loaded pressure switch. Hand-held power tool 10 includes a torque clutch 44, which is provided for setting a maximally transmitted torque from drive unit 62 to tool receptacle 60. Torque clutch 44 includes a setting ring 68, which is provided for an operation by the user (cf. FIG. 2).

Hand-held power tool 10 includes a transmission unit 70. Transmission unit 70 is provided for transforming a speed and/or a torque of drive unit 62 into a speed and/or a torque of tool receptacle 60. Transmission unit 70 includes a plurality of gears, which have a different transmission ratio. In the present exemplary embodiment, transmission unit 70 has two gears. Hand-held power tool 10 includes a gearshifting device, which is provided for setting a gear. The gearshifting device includes an actuation element 72, which is provided for an operation by the user. Actuation element 72 in the present exemplary embodiment is designed as a sliding element. Actuation element 72 of the gearshifting device in the present embodiment is situated on a side of the motor housing 12 opposite handle housing 54. Hand-held power tool 10 includes a rotation direction reversal, which is provided to set a direction of rotation of the tool receptacle 60. The rotation direction reversal includes an actuation element 74, which is provided for an operation by the user. Actuation element 74 in the present exemplary embodiment is designed as a sliding element.

Hand-held power tool 10 is provided electrical power supply by rechargeable battery device 52. Hand-held power tool 10 includes a rechargeable battery interface unit for a coupling to rechargeable battery device 52. The rechargeable battery interface unit for rechargeable battery device 52 is situated at an end of handle housing 54 facing away from motor housing 12. The rechargeable battery interface unit is provided for detachably securing a housing of rechargeable battery device 52 to handle housing 54 of hand-held power tool 10 without the use of tools. The interface unit is provided for an electrical and mechanical connection of hand-held power tool 10 with rechargeable battery device 52. It is also conceivable that hand-held power tool 10, alternatively or in addition, includes an electrical power connector for an electrical connection to an electricity network.

Hand-held power tool 10 includes an output spindle 14, which is provided for transmitting a rotational movement and/or a torque from transmission unit 70 to tool receptacle 60. Output spindle 14 in the present exemplary embodiment is designed to be separate from tool receptacle 60. Output spindle 14 is permanently connected to tool receptacle 60. Output spindle 14 is situated centrally in metal housing 16 in an assembled state.

Metal housing 16 has an outer wall 76, which is designed essentially in the form of a hollow cylinder. Metal housing 16 includes a metal housing axis 42, which is situated on drive and working axis 56 in an assembled state. Metal housing 16 is situated axially between setting ring 68 of torque clutch 44 and drive unit 62 relative to drive and working axis 56 of hand-held power tool 10. Metal housing 16 is spaced axially apart from tool receptacle 60. Metal housing 16 forms a receiving area 18 for fastening additional handle 20. In the present exemplary embodiment, receiving area 18 is provided for non-destructive releasable fastening of additional handle 20 to hand-held power tool 10. Additional handle 20 in the present exemplary embodiment is removable. It is also conceivable that receiving area 18 and additional handle 20 are provided to be permanently connected. Receiving area 18 is provided for an at least rotatably fixed connection of additional handle 20 to hand-held power tool 10.

Receiving area 18 is designed in the form of an essentially cylindrical wall. Additional handle 20 includes a coupling unit 78 and a handle area 80. Receiving area 18 of metal housing 16 and coupling unit 78 are provided to interact for rotatably fixedly attaching additional handle 20 to hand-held power tool 10. Coupling unit 78 includes a sleeve 82, which encompasses receiving area 18 in an assembled state. An outer circumference of receiving area 18 includes a circumferential groove 84, which is provided for guiding sleeve 82 of additional handle 20. On the outer circumference, receiving area 18 includes a wave profile 86, which is provided for a rotatably fixed connection of sleeve 82 with receiving area 18. Sleeve 82 includes engagement means, which are designed to correspond to groove 84 and wave profile 86 and which are provided to interact with groove 84 and wave profile 86 to form a rotatably fixed connection of additional handle 20 to hand-held power tool 10.

Additional handle 20 includes a shaft 88. Shaft 88 has an axis 90, which is situated at least essentially perpendicularly to drive and working axis 56 in an assembled state. Coupling unit 78 and receiving area 18 are provided for arranging additional handle 20 at a selectable angle relative to a circumferential direction of drive and working axis 56. In the present exemplary embodiment, the angle is selectable in increments of approximately 10 degrees. It is also conceivable that the outer circumference of receiving area 18 is designed to be smooth and the angle is freely selectable. One end of additional handle 20 facing away from coupling unit 78 includes handle area 10, which a user grasps with at least one hand for using hand-held power tool 10. Additional handle 20 includes a guard ring 92, which is situated transversely to an axis 90 of shaft 88. Guard ring 92 delimits handle area 80 of additional handle 20 in the direction of coupling unit 78.

Connection area 22 of metal housing 16 is provided for a form-locking connection to motor housing 12 in the circumferential direction. Connection area 22 is provided for a screw connection with motor housing 12. Connection area 22 includes a plurality of screw receptacles 94, 96, which are distributed along the outer circumference of metal housing 16. The screw connection is provided for applying an axial force counter to a working direction on metal housing 16.

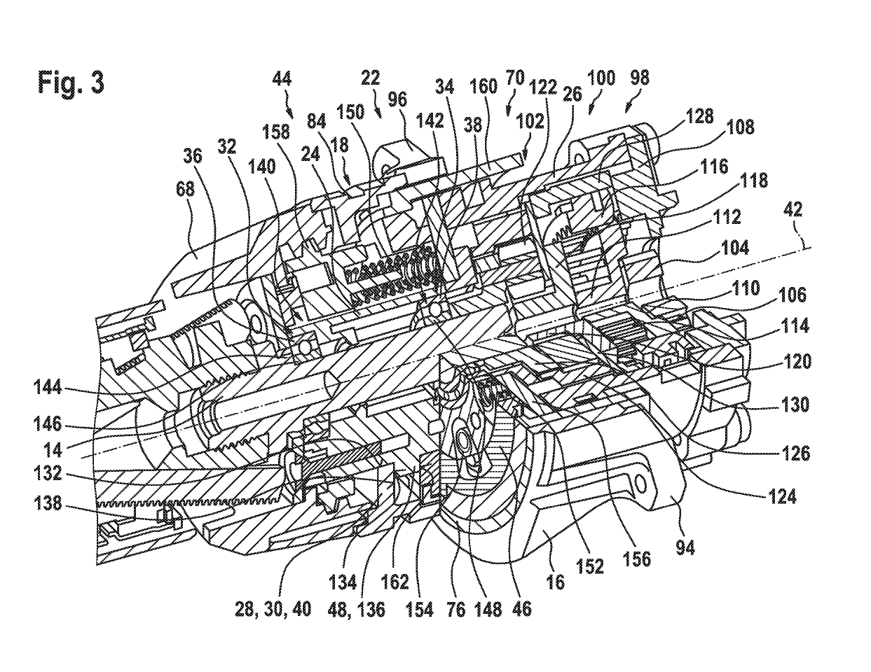

Insulation unit 24 is formed from an electrically non-conductive plastic. Insulation unit 24 in the present exemplary embodiment is formed from a polyamide (cf. FIG. 3). The plastic of insulation unit 24 has a dielectric strength of 25 kV/mm. Insulation unit 24 is provided for a rotatable radial mounting of output spindle 14.

Transmission unit 70 in the present exemplary embodiment is designed as a planetary gear set. Transmission unit 70 includes a transmission housing 26 and a plurality of planetary gear stages 98, 100, 102. Insulation unit 24 includes transmission housing 26. Insulation unit 24 and transmission housing 26 are designed as one piece. Transmission unit 70 in the present exemplary embodiment includes three planetary gear stages 98, 100, 102. Planetary gear stages 98, 100, 102 are situated successively in an axial direction between drive unit 62 and tool receptacle 60. A first of the planetary gear stages is designed as a planetary gear stage 98 on the drive side. The first of planetary gear stages 98 includes a sun wheel 104, a plurality of planetary elements 106, an annulus gear 108 and a planetary carrier 110. Planetary elements 106 are situated rotatably on planetary carrier 110. Annulus gear 108 of first planetary gear stage 98 in the present exemplary embodiment is designed as a transmission cover and is securely screwed to transmission housing 26. Annulus gear 108 includes a collar on the motor side, which forms an axial stop for drive unit 62. One further of the planetary gear stages is designed as a middle planetary gear stage 100. Further planetary gear stage 100 includes a sun wheel 112, which is designed together with planetary carrier 110 of first planetary gear stage 98 as one piece, a plurality of planetary elements 114, an annulus gear 116 and a planetary carrier 118. Planetary elements 114 are rotatably situated on planetary carrier 118. Annulus gear 116 of further planetary gear stage 100 in the present exemplary embodiment is designed as a switching annulus gear. Switching annulus gear is mounted axially moveably in transmission housing 26. A third one of the planetary gear stages is designed as a planetary gear stage 102 on the output side. Third planetary gear stage 102 includes a sun wheel 120, which together with planetary carrier 118 of further planetary gear stage 100 is designed as one piece, a plurality of planetary elements 122, an annulus gear 124 and a planetary carrier 126. Planetary elements 122 are rotatably situated on planetary carrier 126. Planetary carrier 126 is rotatably fixedly connected to output spindle 14. Transmission unit 70 includes a cylindrically designed locking sleeve 128, which surrounds planetary carrier 110 of first planetary gear stage 98 and further planetary gear stage 100 in an assembled state. Transmission unit 70 includes a friction disk 130, which is situated in the axial direction between planetary carrier 110 of second planetary gear stage 100 and planetary elements 122 of third planetary gear stage 102. Friction disk 130 is provided for transmitting an axial force of torque clutch 44 to locking sleeve 128. Friction sleeve 130 is provided for guiding planetary elements 122 of third planetary gear stage 102.

Annulus gear 116 of further planetary gear stage 100 designed as a switching annulus gear, includes two switch positions, each corresponding to one of the gears of transmission unit 70 and each to one of two axial positions. In a first of the switch positions, which corresponds to a first one of the gears, annulus gear 116 is situated near the output side. On the outer circumference, annulus gear 116 includes engagement means, which engage in locking sleeve 128 in the first switch position and lock annulus gear 116 securely in the housing. Planetary elements 122 of further planetary gear stage 100 roll along annulus gear 116 in this switch position of annulus gear 116. In another of the switch positions, which corresponds to another of the gears, annulus gear 116 is rotatably mounted. Planetary elements 114 of further planetary gear stage 100 and planetary carrier 110 of first planetary gear stage 98, which is rotatably fixedly connected to sun wheel 112 of further planetary gear stage 100 engage simultaneously in annulus gear 116. In the second switch position, annulus gear 116, designed as a switching annulus gear, bridges further planetary gear stage 100.

The hand-held power tool housing device includes an axial cross sectional plane, in which insulation unit 24 is situated radially between output spindle 14 and receiving area 18. Insulation unit 24 is situated radially between output spindle 14 and receiving area 18 over an entire axial extension of receiving area 18. Insulation unit 24 completely encloses output spindle 14 in one area of receiving area 18.

Metal housing 16 in the present exemplary embodiment includes three guide elements 28, each of which are provided for radially supporting and guiding insulation unit 24. Guide elements 28 in an assembled state are provided for radially supporting and centering insulation unit 24. Guide elements 28 are provided for guiding and centering insulation unit 24 during an assembly operation. Guide elements 28 and receiving area 18 are designed as one piece. Each of guide elements 28 is molded to an inner side of receiving area 18. Guide elements 28 extend from the inner side of receiving area 18 radially inwardly. Each guide element 28 includes a contact surface 132 aligned radially inwardly, which is provided for contact with an outer circumference of insulation unit 24 during an assembly and/or in an assembled state. The hand-held power tool housing device includes an axial cross sectional plane, in which output spindle 14, insulation unit 24, guide element 28 and receiving area 18 are situated.

Metal housing 16 includes three support elements 30, which are provided in an assembled state for supporting insulation unit 24 in the axial direction. In the present exemplary embodiment, each of support elements 30, together with guide elements 28, are designed as one piece. Each support element 30 includes an axially aligned contact surface 134, which is in contact with insulation unit 24 in an assembled state. Contact surfaces 134 are each designed in the form of circular ring segments. Support elements 30 engage on at least one side in an outer circumference of insulation unit 24. Insulation unit 24 includes at least one support element 136, which is provided for interacting with support elements 30 of metal housing 16. Support element 136 of insulation unit 24 in the present exemplary embodiment is designed as an annular plastic rib, which is molded to a base body of insulation unit 24. Support element 136, together with the base body of insulation unit 24, are designed as one piece. Support element 136 is designed in the form of a ring on an outer circumference of the base body. It is conceivable that insulation unit 24 includes a plurality of support elements, each of which is designed as a ring section. Support element 136 of insulation unit 24 includes a plurality of axially aligned contact surfaces 138, each of which is provided for interacting with the axially aligned contact surfaces 134 of support elements 30 of metal housing 16 for a load transmission.

Insulation unit 24 includes a transmission mounting area and a spindle mounting area. The transmission mounting area and the spindle mounting area are situated axially adjacent to one another. The spindle mounting area includes a receptacle for torque clutch 44. Insulation unit 24 includes two bearing positions 140, 142 in the spindle mounting area for a rotatable mounting of output spindle 14. Hand-held power tool 10 in the present exemplary embodiment includes two antifriction bearings 32, 34 for rotatable mounting of output spindle 14, each of which includes an outer ring 36, 38 directly connected to insulation unit 24. Antifriction bearings 32, 34 in the present exemplary embodiment are each designed as ball bearings. A first one of the antifriction bearings 32 is situated at an end of insulation unit 24 on the output side. Output spindle 14 includes an axial stop 144. First antifriction bearing 32 includes an inner ring 146, which is connected to output spindle 14 in an assembled state. Axial stop 144 of output spindle 14 is in contact with inner ring 146 of first antifriction bearing 32 in an assembled state. Insulation unit 24 includes an axial contact surface, which is in contact with outer ring 36 of first antifriction bearing 32 in an assembled state. First antifriction bearing 32 is provided for transmitting an axial and/or a radial force from output spindle 14 to insulation unit 24. Another antifriction bearing 34 is situated at an end of the spindle mounting area on the output side. The other antifriction bearing 34 is situated immediately adjacent to planet carrier 126 of third planetary gear stage 102. First antifriction bearing 32 and the other antifriction bearing 34 are designed analogously to one another. The other antifriction bearing 34 includes an inner ring 148, which is directly connected to output spindle 14.

Insulation unit 24 projects axially beyond metal housing 16 in an assembled state. The axial extension of insulation unit 24 is greater than an axial extension of metal housing 16. Insulation unit 24 projects beyond metal housing 16 on the output side. In an assembled state, metal housing 16 is situated axially overlapping with the spindle mounting area and the transmission mounting area of insulation unit 24. Receiving area 18 of metal housing 16 for additional handle 20 encloses the spindle mounting area of insulation unit 24.

Metal housing 16 in the present exemplary embodiment includes three bracing elements 40, which extend at least essentially perpendicularly to metal housing axis 42. Bracing elements 40 are situated on an inner circumference of outer wall 76 of metal housing 16 and extend in each case radially inwardly and in the circumferential direction. Bracing elements 40 are each designed in the form of circular ring segments. Bracing elements 40, together with guide elements 28 are designed as one piece. Bracing elements 40 are provided for absorbing deformation forces acting on metal housing 16.

Torque clutch 44 includes a plurality of spring elements 150, 152, 154 and a pressure plate 156. Spring elements 150, 152, 154 are provided for exerting an axial spring force on pressure plate 156. Torque clutch 44 also includes a control element 158, which is provided for interacting with setting ring 68 of torque clutch 44 and for setting a pretension of spring elements 150, 152, 154. Pressure plate 156 is mounted axially moveably on insulation unit 24. Pressure plate 156 is designed in the form of a circular ring and includes six interior segments, each of which form a contact surface for spring elements 150, 152, 154. The pressure plate is situated coaxially in relation to drive and working axis 56 of hand-held power tool 10. Torque clutch 44 includes a blocking element 46 and an actuation element 160 for blocking element 46. In an assembled state, actuation element 160 overlaps pressure plate 156. Blocking element 46 is provided in an operating state for disengaging torque clutch 44 and for supporting a blocking force against metal housing 16. Blocking element 46 is provided for delimiting an axial movement of pressure plate 156. Blocking element 46 is provided for locking pressure plate 156 in the axial direction. Actuation element 160 is designed as a cylindrical sleeve. Actuation element 160 situated in the axial direction between blocking element 46 and metal housing 16. Actuation element 160 is situated in the axial direction between pressure plate 156 and metal housing 16.

Insulation unit 24 includes at least one insulation element 48, which electrically insulates blocking element 46 and metal housing 16 from one another in an assembled state. In the present exemplary embodiment, insulation element 48 together with support element 136 of insulation unit 24, are designed as one piece. Insulation element 48 in the present exemplary embodiment is designed as an annular plastic rib, which is molded to a base body of insulation unit 24. Insulation element 48 of insulation unit 24 includes a plurality of contact surfaces 138 aligned on the output side, each of which is provided for a contact with axially aligned contact surfaces 162 of support element 30 of metal housing 16. Insulation element 48 of insulation unit 24 includes a contact surface 162 aligned on the output side, which is provided for a contact with blocking element 46. Insulation element 48 is situated in the axial direction between support elements 30 of metal housing 16 and blocking element 46. Receiving area 18 for additional handle 20 overlaps insulation element 48 in an assembled state.

What is claimed is:

1. A hand-held power tool, comprising:
a motor housing;
an output spindle;
at least one metal housing, which includes a receiving area for fastening an additional handle and a connection area formed as one piece with the receiving area for a free-of-play, rotatably-fixed connection to the motor housing; and
an insulation unit, which electrically insulates the output spindle and the metal housing from one another in an assembled state.

2. The hand-held power tool as recited in claim 1, wherein the insulation unit is provided for a rotatable, at least radial mounting of the output spindle.

3. The hand-held power tool as recited in claim 2, wherein the insulation unit includes a transmission housing.

4. The hand-held power tool as recited in claim 2, wherein, in at least one axial cross sectional plane, the insulation unit is radially situated between the output spindle and the receiving area.

5. The hand-held power tool as recited in claim 4, wherein the metal housing includes at least one guide element, which is provided for at least one of radially supporting and radially guiding the insulation unit.

6. The hand-held power tool as recited in claim 4, wherein the metal housing includes at least one support element, which is provided in the assembled state for supporting the insulation unit in the axial direction.

7. The hand-held power tool as recited in claim 4, further comprising:
at least one antifriction bearing for rotatable mounting of output spindle, wherein the at least one antifriction bearing includes at least one outer ring directly connected to the insulation unit.

8. The hand-held power tool as recited in claim 4, wherein the insulation unit projects axially beyond the metal housing in an assembled state.

9. The hand-held power tool as recited in claim 4, wherein the metal housing includes at least one bracing element, which extends at least essentially perpendicularly to a metal housing axis.

10. The hand-held power tool as recited in claim 4, further comprising:
a torque clutch, which includes a blocking element configured to be selectively provided in at least one operating state for disengaging the torque clutch and for supporting a blocking force against the metal housing.

11. The hand-held power tool as recited in claim 10, wherein the insulation unit includes at least one insulation element, which electrically insulates the blocking element and the metal housing from one another in an assembled state.
